(19) United States
(12) Patent Application Publication
(10) Pub. No.: US 2012/0326437 A1
(43) Pub. Date: Dec. 27, 2012

(54) Water Cooler Adapter

(76) Inventor: Ernest O. Santos, Honolulu, HI (US)

(21) Appl. No.: 13/079,028

(22) Filed: Jun. 27, 2011

(51) Int. Cl. F16L 39/00

(52) U.S. Cl. 285/129.1

(57) ABSTRACT

The invention provides the capability to add a common five (5) gallon water jug, commonly used on office water coolers, to the top of a water cooler jug. The invention consists of a collar which securely holds the water bottle and allows water to drain out.

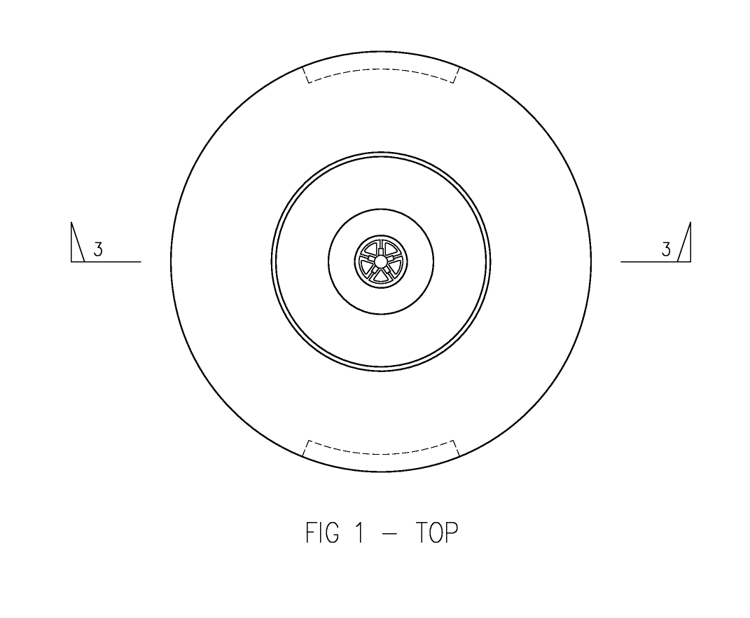

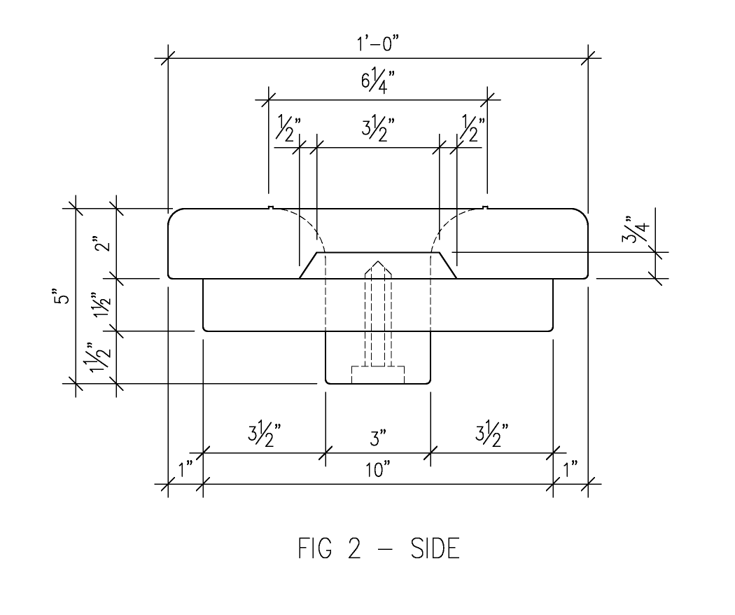

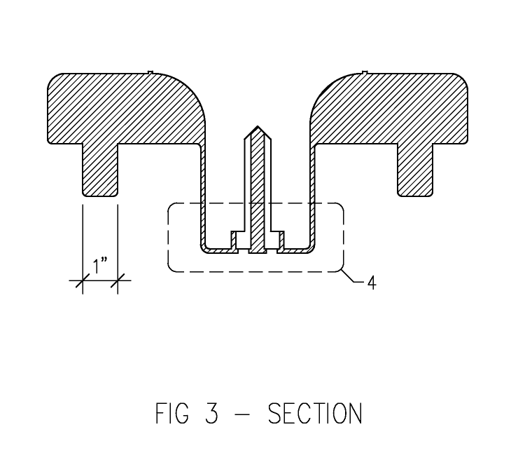

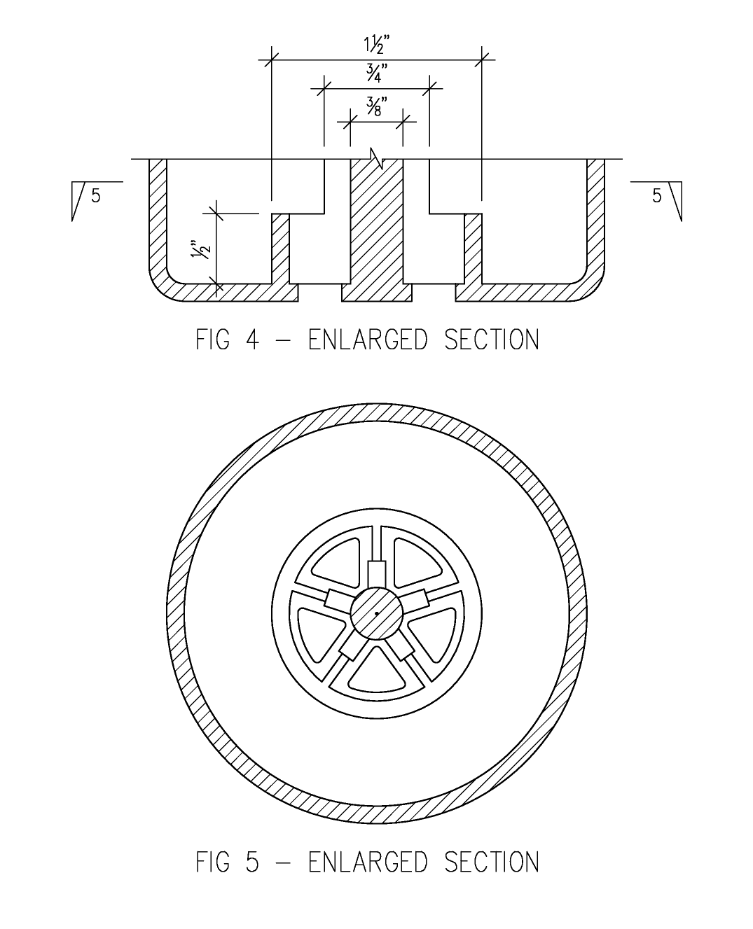

Aqua Lid Model: 1/4 FIG. (1) is a view of the top of water cooler looking down.

Center is where the 5 gallon water bottles sits atop with the neck in first.

Aqua Lid Model: 2/4 FIG. (2) is a side view of water cooler adapter with measurements of diagram.

Aqua Lid Model: 3/4 FIG. (3) is a cut away side view of water cooler adapter that displays thickness in diagram of water cooler cover.

Aqua Lid Model: 4/4 FIG. (4) top drawing is a cut away side view of the center of water cooler adapter where the neck of the water bottle sits in.

Aqua Lid Model: 4/4 FIG. (4) bottom drawing is the circular pattern in the middle of water cooler cover.

1. Water cooler Adapter is a lid that replaces the cover of a 5 gallon water cooler. By switching the cover, the cooler will be able to mount a 5 gallon water bottle which will increase the amount of water to be served.
From 5 gallon it now becomes a 10 gallon water cooler. The cooler will be able to deliver more water to serve.
This water cooler adapter is made of durable plastic to withstand the weight of the 5 gallon water bottle. It is manufactured with a water tube in the center that will act as the channel for the water flow. It will sit atop a water cooler with a breeder to allow ventilation so that water will flow throw easily. This is my claim for the water cooler adapter.
